(19) United States
(12) Patent Application Publication
(10) Pub. No.: US 2021/0341090 A1
(43) Pub. Date: Nov. 4, 2021

(54) Hydraulic Continuous Roll Joint

(71) Applicant: RE2, Inc., Pittsburgh, PA (US)

(72) Inventor: Stephen Somple, Pittsburgh, PA (US)

(21) Appl. No.: 17/307,280

(22) Filed: May 4, 2021

Related U.S. Application Data
(60) Provisional application No. 63/019,537, filed on May 4, 2020.

(51) Int. Cl. F16L 39/06; F16L 39/02; B25J 17/02

(52) U.S. Cl. CPC F16L 39/06; B25J 17/0241; F16L 39/02

(57) ABSTRACT

A fluid activated continuous roll joint apparatus for use in various robotic applications. The continuous roll joint apparatus can include an outer housing, a plurality of collapsible hoses, and a rotor assembly. The outer housing can include a cylindrical inner cavity. The plurality of collapsible hoses can be disposed around a perimeter of at least a portion of the cylindrical inner cavity. The rotor assembly can include a plurality of rollers distributed radially around a rotor frame, where each roller of the plurality of rollers can be positioned to engage (pinch) a collapsible hose of the plurality of collapsible hoses. In an example, the continuous roll joint is activated when fluid is pumped through the plurality of collapsible hoses. Which rotates the rotor through inaction between the collapsible hoses and the rollers.

### PRIORITY APPLICATIONS

This application claims the benefit of priority to U.S. Provisional Patent Application Ser. No. 63/019,537, filed May 4, 2020, the content of which is incorporated by reference in its entirety.

### TECHNICAL FIELD

This document pertains generally, but not by way of limitation, to robotic end effectors. More particularly, this disclosure relates to, but not by way of limitation, a hydraulically powered continuous roll joint for use as a wrist of a robotic arm, among other things.

### BACKGROUND

Robotic arms can include a wide variety of joint mechanisms to accomplish different tasks. One type of robotic joint is a wrist joint that involves a rotation about a longitudinal axis running through the center of the wrist joint. Robotic joints can also utilize a wide variety of different drive mechanisms ranging from hydraulic to electric to pneumatic. Pneumatically or hydraulically driven mechanisms utilize a fluid, typically air, water, or oil, to drive an internal mechanism. Typically, hydraulically driven mechanisms involve cylinders or gear systems.

Typical hydraulic or pneumatic mechanisms require tight tolerances to contain high pressure fluid used to power the mechanism. Additionally, due to the high pressures often involved in hydraulic or pneumatic systems maintenance can also be a concern for long term operations. Accordingly, there is a need for a lower maintenance design that better contains hydraulic fluid during operation.

### OVERVIEW

The mechanism discussed herein is a rotary actuator or roll joint with a fluid (pneumatic/hydraulic) motor for use with robotic manipulator arms. In an example, the fluid motor is designed to utilize water as the driving medium. Other examples of the fluid motor can be driven with oil, air, or a similar fluidic medium. Non-compressible fluid mediums will provide optimal functionality for most applications. However, compressible mediums, such as air, may also be useful in certain applications, such as where a natural dampening effect is considered useful. The fluid drive mechanism includes of a set of collapsible hoses routed between a roller set and outer housing. The collapsible hoses are configured to have an inlet for pressurization and outlet to exhaust the fluid. A rotor assembly with multiple distributed rollers make up the central drive mechanism. The rollers collapse or pinch the tubes against an outer housing creating a movable restriction. When pressurized, the tubes drive against the rollers, which are mounted radially on the central rotor assembly. The pressure in the tubes forces the rollers to move in the radial path of the tubing and thus drive the rotor. Reversing the flow direction in the tubes drives the rotor assembly in the opposite direction. In an example embodiment, the shaft of the rotor assembly drives the input of an integral planetary gear reduction set which increases torque at the output shaft. Other examples can utilize different reduction gearing mechanism, or directly couple to the rotor output shaft. An interface plate can be fitted to the output shaft to facilitate attachment of end of arm tooling (EOAT). To provide pressure (e.g., fluid) supply to the EOAT, a fluidic rotary union can be incorporated in the output shaft.

The rotary actuator discussed herein was designed for underwater use, but is similarly applicable to other environments. The rotary actuator can be scaled, in terms of rotary power output, by increasing/decreasing tubing size, changing output gearing, and/or adding additional circuits of tubing and/or roller sets. The present rotary actuator benefits from completely closed loop fluid circuits that deduce the potentials for leaks and simplify maintenance as the primary drive mechanism (e.g., the fluid circuit) can be easily replaced if wear occurs.

This Overview is intended to provide non-limiting examples of the present subject matter—it is not intended to provide an exclusive or exhaustive explanation. The Detailed Description below is included to provide further information about the present apparatuses and methods.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 is an illustration providing an exploded perspective view of a fluid driven continuous roll joint, according to some example embodiments.

FIG. 2A is a perspective view of a fluid driven continuous roll joint, according to some example embodiments.

FIG. 2B is cut-away perspective view of a fluid driven continuous roll joint, according to some example embodiments.

FIG. 2C is a cross-sectional view of a fluid driven continuous roll joint, according to some example embodiments.

FIGS. 2D-2E are perspective views of a portion of a fluid driven continuous roll joint, according to some example embodiments.

FIG. 2F is a top view of a fluid driven continuous roll joint, in accordance with some examples.

The headings provided herein are merely for convenience and do not necessarily affect the scope or meaning of the terms used or of the scope of any disclosure.

### DETAILED DESCRIPTION

The present application relates to devices, systems and mechanisms for providing a continuous roll joint. More specifically, the present application discusses a continuous roll joint that utilizes a fluid drive mechanism including collapsible hoses.

The inventors discovered that utilizing a set of collapsible internal hoses in combination with a central rotor mechanism can solve many of the traditional challenges with fluid (e.g., hydraulic or pneumatic) drive joints. The mechanism outlined herein is designed as a rotary actuator or roll joint with a fluid motor for use with robotic manipulator arms using water as the driving medium. In an example, the driving mechanism includes a set of collapsible hoses located between a roller set and outer housing. In this example, the collapsible hoses are configured to have an inlet for pressurization and outlet to exhaust, which are reversible to change output rotation direction. The rollers collapse or pinch the tubes against an outer housing creating a restriction. In this example, when pressurized, the tubes drive against the rollers which are mounted radially on a central rotor assembly. The pressure in the tubes forces the rollers to move in the radial path of the tubing and thus drives the rotor. Reversing the flow direction in the tubes drives the rotor assembly in the opposite direction. In some examples, the shaft of the rotor assembly drives the input of an integral planetary gear reduction set which increases torque at the output shaft. An interface plate is fitted to the output shaft to facilitate attachment of end of arm tooling (EOAT). To provide pressure supply to the EOAT, a fluidic rotary union is incorporated in the output shaft.

Design Elements in some examples can include:
1. Collapsible tubes constructed of a woven material outer shell with internal water-tight membrane. In this example, the natural state of the collapsible tubes allows them to lay flat before pressurization. The ability of the collapsible tubes to lay flat can minimize the resistance the rollers encounter as they roll in the radial path. in comparison, typical peristaltic tube has “memory” and can require significant force to collapse the tubing.
2. Fluid drive mechanism can include dual circuits having two sets of parallel tubes or four tubes total. Each tube can cover a range of approximately 120 degrees with three rollers per circuit spaced at 120 degrees. This arrangement ensures that four rollers are being driven at any given time with minimal overlap to prevent blow by in a circuit. This can optimize output in a compact envelope. In some examples, each circuit can be rotationally offset to further improve operation of the roll joint by distributing force application radially. The fluid drive can also include, in some examples, more than the two circuits illustrated, which can be used as a mechanism to further increase radial output power generated by the roll joint.
3. Flow and pressure can be regulated at the inlet or outlet to control rotational speed and torque output.
4. Rotational direction can be changed by simply reversing pressure and exhausting ends of the tubing. Fluid direction through the tubes determines rotational output direction. For example, if fluid is pumped into the exhaust ports, so the inlet ports become outlet ports, the rotational direction of the output shaft is reversed.
5. The use of tubing isolates the mechanical components from the working medium, in this case, water. The design is highly contamination resistant and not subject to wear associated with other hydraulic motor types which require tight tolerances for operation. Isolation of the fluid medium reduces corrosion and wear on all other parts of the fluid motor in particular, as the fluid is completely isolated within the tubes.
6. The design is scalable for various applications. This can be accomplished by either increasing/decreasing tubing and mechanical components or by adding additional circuits of tubing and roller sets on the central rotor assembly.

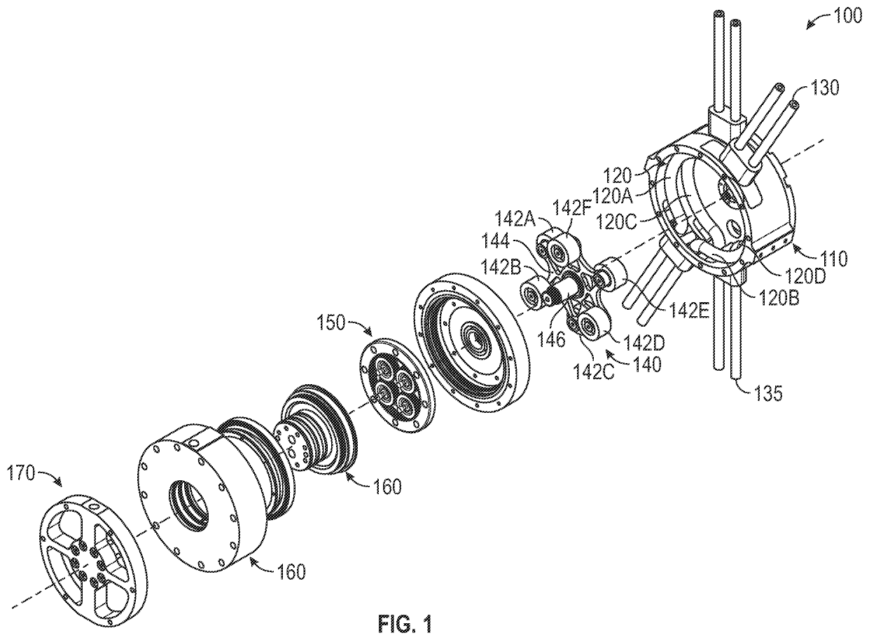

FIG. 1 is an illustration providing an exploded perspective view of a fluid driven continuous roll joint, according to some example embodiments. In this example, the continuous roll joint 100 can include an outer housing 110, a number of collapsible hoses 120, fluid inlets 130, fluid outlets 135, a rotor assembly 140, a planetary gear set 150, a fluidic rotary union 160, and an interface plate 170. In this example, the primary components of the fluid driven continuous roll joint 100 are associated with the outer housing 110. In an example, the outer housing 110 contains four (4) collapsible hoses 120 (individually labeled in FIG. 1 as 120A-120D). In this example, the collapsible hoses 120 are arranged into two parallel circuits that are radially offset within the outer housing 110. The radial offset can assist in smoothing rotary operation, as it prevents a dead spot where the fluid circuits transition to the inlets or outlets. The outer housing 110 can include a cylindrical inner cavity that supports the collapsible hoses 120 and provide a smooth surface for rollers to traverse.

The outer housing 110 also contains, when assembled, a central rotor assembly 140. In this example, the rotor assembly 140 includes two sets of three rollers 142A-142F distributed in 120-degree radial increments on either side of a rotor frame 144. The rotor frame 144 also includes a rotor shaft 146 that can couple the fluid drive mechanism to a gear set, such as the planetary gear set 150. Upon assembly of the rotor assembly 140 into the outer housing 110, the rollers 142A-142F will compress portions of the collapsible hoses to form movable restrictions that operate to rotate the rotor assembly 140 upon fluid flow through inlets 130 and outlets 135 of the collapsible hoses 120, such as hoses 120A-120D. In an embodiment, the rollers 142A-142F disposed on a first side of the frame may be radially offset from rollers on a second side of the frame to smooth out the rotary torque generated by the drive mechanism. In other examples, the central rotor assembly 140 can include more or fewer rollers.

Each fluid circuit includes an inlet 130 coupled to a collapsible hose 120 further coupled to an outlet 135. The terms inlet and outlet are merely used as a convenience, as the fluid can flow in either direction to produce clockwise or counterclockwise rotation of the output rotor shaft 146. In this example, the collapsible hoses 120 are illustrated as separate hoses that terminate in a fluidic coupler on the inlet and outlet sides. In other examples, the collapsible hoses 120 can run continuously from inlet 130 to outlet 135.

As indicated above, in this example, the fluid drive mechanism is coupled via the rotor shaft 146 to a planetary gear set 150, which in turn is coupled to a fluidic rotary union 160. The planetary gear set 150 operates to increase torque available to operate the continuous roll joint. Other gear mechanisms can be coupled to the rotor shaft 146 to accomplish any variety of speed variations and/or torque variations as needed for the particular application. The fluidic rotary union 160 includes structures to pass fluid between the continuous roll joint and the interface plate 170 that couples end of arm tools to the continuous roll joint.

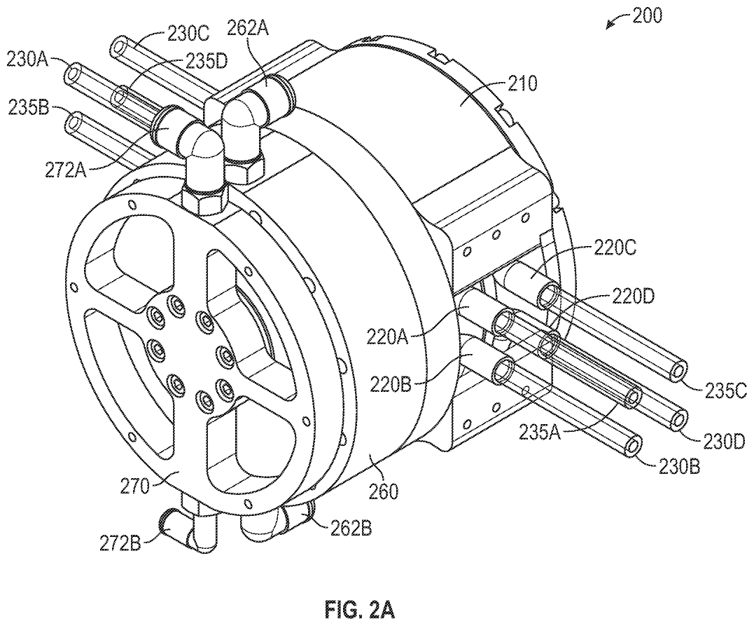

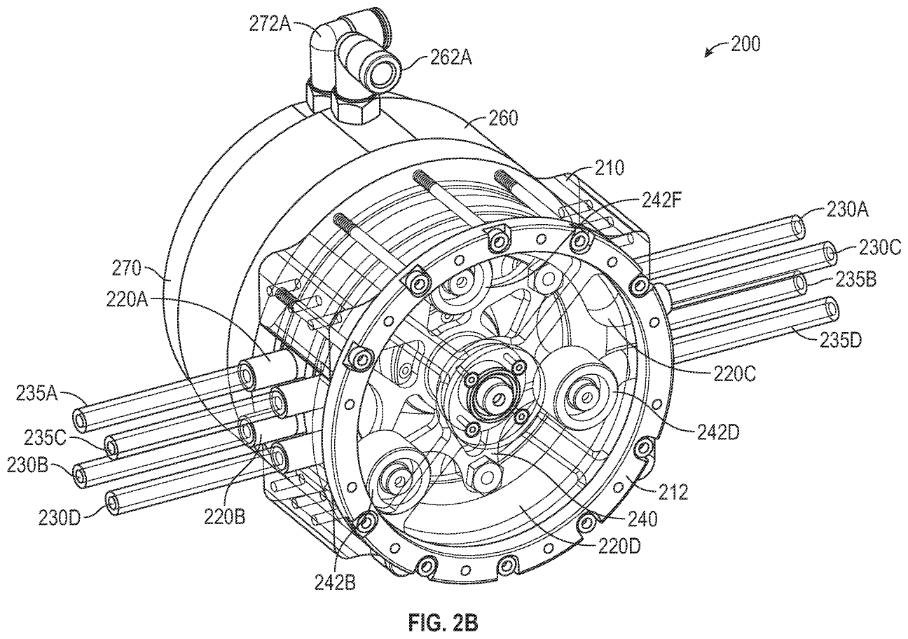

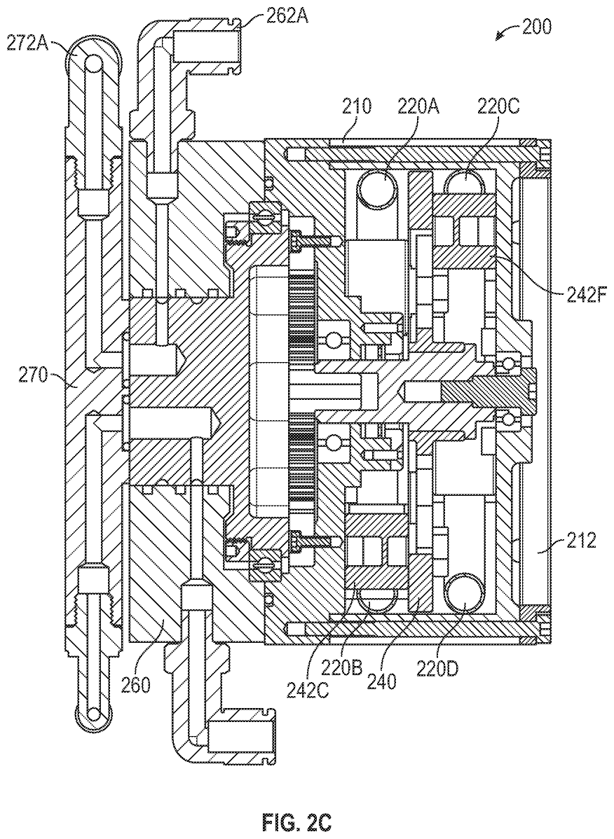

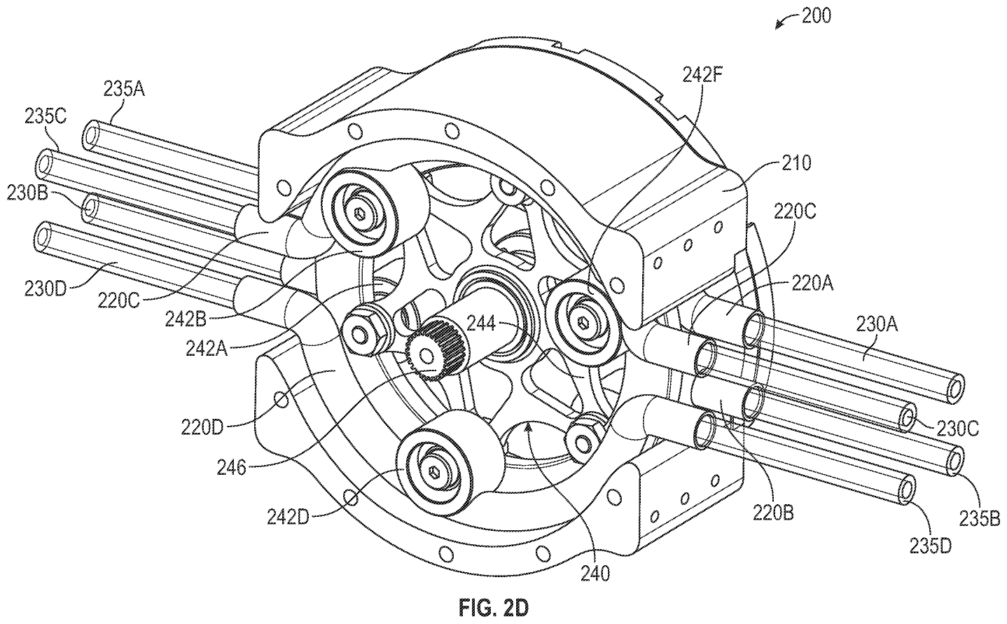

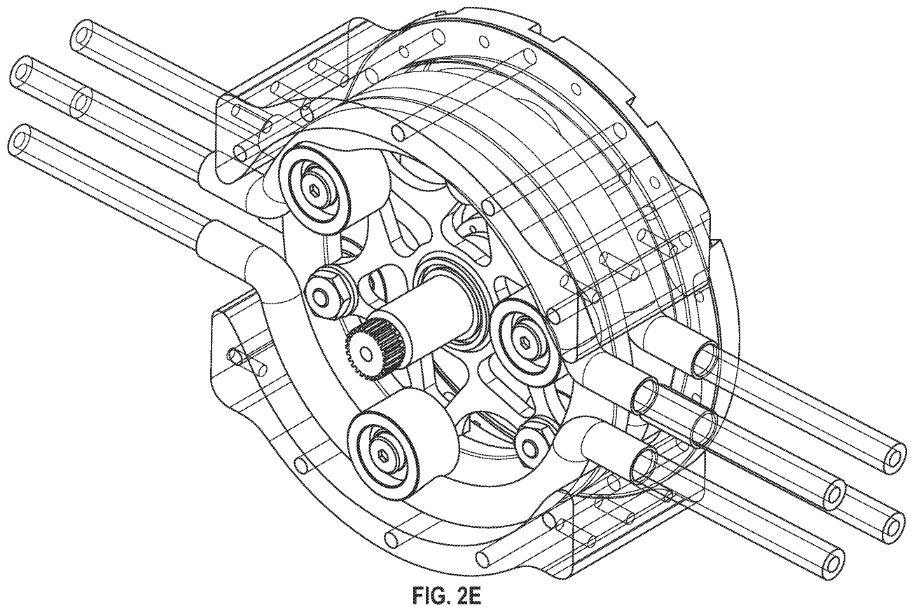

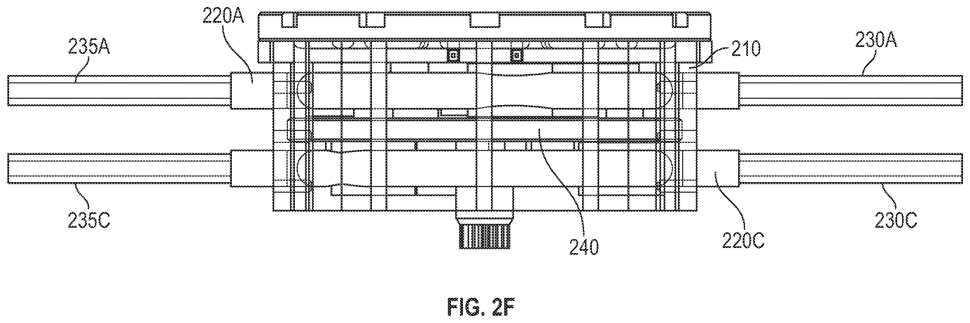

FIGS. 2A is a perspective view of a fluid driven continuous roll joint 200, according to some example embodiments. In this example, the continuous roll joint 200 can include components such as an outer housing 210, collapsible hoses 220A-220D, inlets 230A-230D, outlets 235A-235D, a fluidic union 260, union fluid ports 262A, 262B, an interface plate 270, and interface fluid ports 272A, 272B. In this example, the collapsible hoses 220A-220D are arranged in two parallel circuits, which are not radially offset.

FIG. 2B is cut-away perspective view of a fluid driven continuous roll joint 200, according to some example embodiments. In this example, a rotor assembly 240 is visible through housing cover plate 212. The rotor assembly 240 can include rollers 242A-242F (collectively discussed as rollers 242), with rollers 242B, 242D, and 242F visible and coupled to the outer side of rotor frame 244. In this example, the rollers 242 are radially distributed at 120-degree intervals with three rollers on each side of the rotor frame 244. The rollers are offset 60 degrees between the outer and inner sides of rotor frame 244. The configuration of rollers 242 provides for smooth operation of the roll joint 200. In other examples, more rollers can be utilized to increase output power and/or further smooth rotary operation of the roll joint 200. In the illustrated configuration at least two rollers on each side of the rotor frame 244 will be in driven contact with a collapsible tube (e.g., one of collapsible tubes 220) at all times throughout the rotation of the rotor frame 244.

FIG. 2C is a cross-sectional view of a fluid driven continuous roll joint 200, according to some example embodiments. The cross-sectional view illustrates how the rollers pinch the collapsible hoses (220A, 220B, 220C, and 220D, collectively referenced as collapsible hoses 220), such as roller 242C engaging collapsible hose 220B and rollers 242F engaging collapsible hose 220C. The cross-section view also illustrates the fluid passages within the fluidic rotary union 260 and the interface plate 270.

FIGS. 2D-2E are perspective views of a portion of a fluid driven continuous roll joint, according to sonic example embodiments. In this example, the engagement between the rollers (242B, 242D, 242F, collectively referenced as rollers 242) and collapsible hoses 220C, 220D are illustrated, with the rollers (242B, 242D, 242F) each pinching one of the hoses 220C, 220D. In this example, the outer housing 210 includes a cylindrical inner surface that supports the collapsible hoses 220. In inner cylindrical surface of the outer housing 210 also provides support for the rollers 242 as they pinch the respective collapsible hoses 220. In this example, roller 242B and roller 242F are engaging collapsible hose 220C, and roller 242D is engaging collapsible hose 220D—enagement between the rollers and the hoses involves pinching the hose flat against the inner cylindrical surface of the outer housing 210. In this example, the collapsible tubes 220A-220D include an outer woven-fabric covering with the inner tubing extending beyond the outer covering to form inlets 230A-230D and outlets 235A-235D. As shown in FIG. 2D, the rotor frame 244 is coupled to rotor shaft 246, which provide rotational output from the roll joint 200.

In this example, the rotor frame 240 is positioned between the two sets of collapsible hoses. Collapsible hoses 220C and 220D are positioned on a first or front side of the rotor frame 240, while collapsible hoses 220A and 220B are positioned on the second or back side of the rotor frame 240. In this example, the terms front and back are merely used as relational terms to describe the relative positions in reference to the rotor frame 240. The collapsible hoses 220 are also positioned in opposing pairs of hoses in this example. Collapsible hose 220A is opposite and superior to collapsible hose 220B, similarly collapsible hose 220C is superior to collapsible hose 220D, which is inferior to collapsible hose 220C. The terms superior and inferior are merely used to describe the relationship between different structures, with superior meaning above or top-most and inferior meaning below or bottom most. The terms superior and inferior are used in reference to the orientation of the device or apparatus in the figure being discussed. The continuous roll joint 200 does not necessarily have a top and a bottom. In this example, each of the collapsible hoses spans greater than 120 degrees of an inner perimeter of the outer housing 210 and up to 180 degrees of the inner perimeter of the outer housing 210.

In this example, in order to rotate the rotor frame 240 to generate a rotational output at rotor shaft 246 fluid can be pumped into collapsible hoses 220A and 220C in a first direction and into collapsible hoses 220B and 220D in an opposite second direction (as illustrated by the opposing orientation of inlets 230A and 230C versus inlets 230B and 230D). In certain examples, outlets 235A and 235C are fluidically coupled to inlets 230B and 230D, respectively. In this configuration, fluid is pumped into inlets 230A and 230C and exhausted from outlets 235B and 235D, but otherwise stays contained within the collapsible hoses 220 of the roll joint 200.

FIG. 2F is a top view of a fluid driven continuous roll joint, in accordance with some examples. In this example, collapsible hose 220A and collapsible hose 220C are illustrated along with inlets 230A, 230C and outlets 235A, 235C. The top view also more clearly illustrates how the rotor assembly 240 is positioned between the two circuits of collapsible hoses with rollers extending from opposing sides of the rotor frame.

The above detailed description includes references to the accompanying or incorporated drawings, which form a part of the detailed description. The drawings show, by way of illustration, specific embodiments in which the invention can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments can be used, such as by one of ordinary skill in the art upon reviewing the above description. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

1. A continuous roll joint apparatus comprising:
an outer housing with a cylindrical inner cavity;
a plurality of collapsible hoses disposed around a perimeter of at least a portion of the cylindrical inner cavity; and
a rotor assembly including a plurality of rollers distributed radially around a rotor frame, each roller of the plurality of rollers positioned to engage a collapsible hose of the plurality of collapsible hoses.

2. The continuous roll joint apparatus of claim 1, wherein each collapsible hose of the plurality of collapsible hoses includes a fluid inlet and a fluid outlet.

3. The continuous roll joint apparatus of claim 2, wherein the rotor assembly is rotatable in response to fluid pumped into the fluid inlet through interaction between pressure within each collapsible hose of the plurality of collapsible hoses and the plurality of rollers.

4. The continuous roll joint apparatus of claim 1, wherein the plurality of rollers are distributed around an outer radial edge of the rotor frame.

5. The continuous roll joint apparatus of claim 4, wherein the plurality of rollers are distributed at 60 degree intervals around the outer radial edge of the rotor frame.

6. The continuous roll joint apparatus of claim 5, wherein a first half of the plurality of rollers are distributed around a first side of the rotor frame, and a second half of the plurality of rollers are distributed around a second side of the rotor frame.

7. The continuous roll joint apparatus of claim 1, wherein the plurality of collapsible hoses includes a first two hoses positioned around the perimeter of the at least a portion of the cylindrical inner cavity on a first side of the rotor frame; and
wherein the plurality of collapsible hoses includes a second two hoses positioned around the perimeter of the at least a portion of the cylindrical inner cavity on a second side of the rotor frame.

8. The continuous roll joint apparatus of claim 1, wherein the plurality of collapsible hoses includes at least one pair of collapsible hoses positioned opposite each other around the perimeter of the cylindrical inner cavity.

9. The continuous roll joint apparatus of claim 8, wherein each collapsible hose of the pair of spans at least 120 degrees of the perimeter of the cylindrical inner cavity.

10. A hydraulic continuous roll joint device comprising:
an outer housing with a cylindrical inner cavity;
a first pair of opposing collapsible hoses disposed around a perimeter of at least a portion of the cylindrical inner cavity;
a second pair of opposing collapsible hoses disposed around a perimeter of at least a portion of the cylindrical inner cavity; and
a rotor assembly including a plurality of rollers distributed radially around a rotor frame, each roller of the plurality of rollers positioned to engage a collapsible hose of the first pair of collapsible hoses or the second pair of collapsible hoses.

11. The hydraulic continuous roll joint device of claim 10, wherein the first pair of opposing collapsible hoses is positioned on a first side of the rotor assembly; and
wherein the second pair of opposing collapsible hoses is positioned on a second side of the rotor assembly.

12. The hydraulic continuous roll joint device of claim 10, wherein each collapsible hose of the first pair of opposing collapsible hoses and the second pair of opposing collapsible hoses includes a woven-fabric outer cover.

13. The hydraulic continuous roll joint device of claim 10, wherein first pair of opposing collapsible hoses includes a first superior hose and a first inferior hose; and
wherein the second pair of opposing collapsible hoses includes a second superior hose and a second inferior hose.

14. The hydraulic continuous roll joint device of claim 13, wherein the rotor assembly is rotatable in response to fluid pumped in a first direction through the first superior hose and the second superior hose and fluid pumped in a second direction through the first inferior hose and the second inferior hose.

15. The hydraulic continuous roll joint device of claim 10, wherein the plurality of rollers are distributed around an outer radial edge of the rotor frame.

16. The hydraulic continuous roll joint device of claim 15, wherein the plurality of rollers are distributed at 60 degree intervals around the outer radial edge of the rotor frame.

17. The hydraulic continuous roll joint device of claim 16, wherein a first half of the plurality of rollers are distributed around a first side of the rotor frame, and a second half of the plurality of rollers are distributed around a second side of the rotor frame.

18. The hydraulic continuous roll joint device of claim 10, wherein each collapsible hose of the first pair of opposing collapsible hoses and the second pair of opposing collapsible hoses spans at least 120 degrees of the perimeter of the cylindrical inner cavity.

19. The hydraulic continuous roll joint device of claim 18, wherein each collapsible hose of the first pair of opposing collapsible hoses and the second pair of opposing collapsible hoses spans less than 180 degrees of the perimeter of the cylindrical inner cavity.

20. A fluid activated roll joint apparatus comprising:
a housing including a smooth surface forming an inner cavity;
a pair of collapsible hoses positioned around a perimeter of the inner cavity, each collapsible hose of the pair of collapsible hoses including an inlet and an outlet extending outside the housing; and
a rotor assembly including a plurality of rollers distributed radially around a rotor frame, each roller of the plurality of rollers positionable within the inner cavity to pinch a collapsible hose of the pair of collapsible hoses against the smooth surface.
